(19) United States
(12) Patent Application Publication
(10) Pub. No.: US 2019/0325808 A1
(43) Pub. Date: Oct. 24, 2019

(54) DISPLAY SYSTEM, DRIVER AND METHOD THEREOF FOR VOLTAGE OFFSET ADJUSTMENT

(71) Applicant: Novatek Microelectronics Corp., Hsinchu (TW)

(72) Inventors: Keko-Chun Liang, Hsinchu City (TW); Jhih-Siou Cheng, New Taipei City (TW); Wen-Hsin Cheng, Hsinchu City (TW)

(73) Assignee: Novatek Microelectronics Corp., Hsinchu (TW)

(21) Appl. No.: 15/957,910

(22) Filed: Apr. 20, 2018

(51) Int. Cl. G09G 3/20

(52) U.S. Cl. CPC G09G 3/2092; G09G 2310/027; G09G 2310/0291; G09G 2320/0204

(57) ABSTRACT

A driver of a display panel comprises an operational amplifier and a bias control circuit. The operational amplifier outputs an output signal to drive the display panel according to a bias voltage. The bias control circuit is coupled to the operational amplifier and is configured to output the bias voltage to the operational amplifier, wherein the bias control circuit generates the bias voltage according to a random bit stream. The bias voltage is changed according to signal levels of the random bit stream, and a systematic voltage offset of the operational amplifier is adjusted according to the bias voltage. A method adapted to a driver of a display panel, and a display system are also introduced.

### BACKGROUND

### Technical Field

The disclosure generally relates to a display system, a driver, and a method thereof, and more particularly relates to display system, a driver, and a method thereof that are capable of biasing an operational amplifier according to a random bit stream.

### Description of Related Art

Operational amplifiers are a basic component of electronic circuits and are applied to a wide variety of purposes. Real operational amplifiers are suffered by voltage offsets which cause drifts in the operational amplifiers. The voltage offset may be classified to a systematic voltage offset and a random voltage offset according to factors that generate the voltage offsets such as manufacturing process, a circuit design, a size and type of transistors and the operating temperature. Since an operational amplifier may produce the output signals that are typically hundreds or thousands of times larger than the difference between its input terminals, the voltage offsets may severely influence to the output signal of the operational amplifier.

For example, in a field of display panel, the voltage offsets of the operational amplifiers may cause the errors or noises on the driving signals, and may create visual artifacts on the display.

Therefore, it would be desirable to mitigate the influences of voltage offsets of the operational amplifier, and to achieve effect of smooth displaying on the display panel.

Nothing herein should be construed as an admission of knowledge in the prior art of any portion of the present disclosure.

### SUMMARY

A display system, a driver of a display panel, and a method thereof are introduced herein.

The driver of the display panel includes an operational amplifier and a bias control circuit. The operational amplifier outputs an output signal to drive the display panel according to a bias voltage. The bias control circuit is coupled to the operational amplifier and is configured to output the bias voltage to the operational amplifier. The bias control circuit may generate the bias voltage according to a random bit stream.

The bias voltage may be used to adjust a systematic voltage offset of the operational amplifier; and the bias voltage is changed according to signal levels of the random bit stream.

The method adapted to a driver of a display panel includes steps of providing a random bit stream; generating a bias voltage according to the random bit stream, wherein the bias voltage is configured to bias an operational amplifier; and outputting an output signal according to the bias voltage, wherein the output signal is configured to drive the display panel.

The display system includes a display panel and a driver. The display panel is configured to display image data according to an output signal. The driver is coupled the display panel, and the driver includes an operational amplifier and a bias control circuit. The operational amplifier outputs an output signal to drive the display panel according to a bias voltage. The bias control circuit is coupled to the operational amplifier and is configured to output the bias voltage to the operational amplifier. The bias control circuit may generate the bias voltage according to a random bit stream.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a display system with a driver according to an embodiment of the disclosure.

FIG. 2A illustrates as schematic diagram a driver according to an embodiment of the disclosure.

FIG. 2B illustrates an example of adjusting a systematic voltage offset of an operational amplifier according to an embodiment of the disclosure.

FIG. 3A illustrates detailed structures of a driver according to an embodiment of the disclosure.

FIG. 3B illustrates examples of adjusting a systematic voltage offsets according to embodiments of the disclosure.

FIG. 4A and FIG. 4B illustrate detailed structures of operational amplifiers according to different embodiments of the disclosure.

FIG. 5 illustrates a method of biasing an operation amplifier according to an embodiment of the disclosure.

### DESCRIPTION OF THE EMBODIMENTS

It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

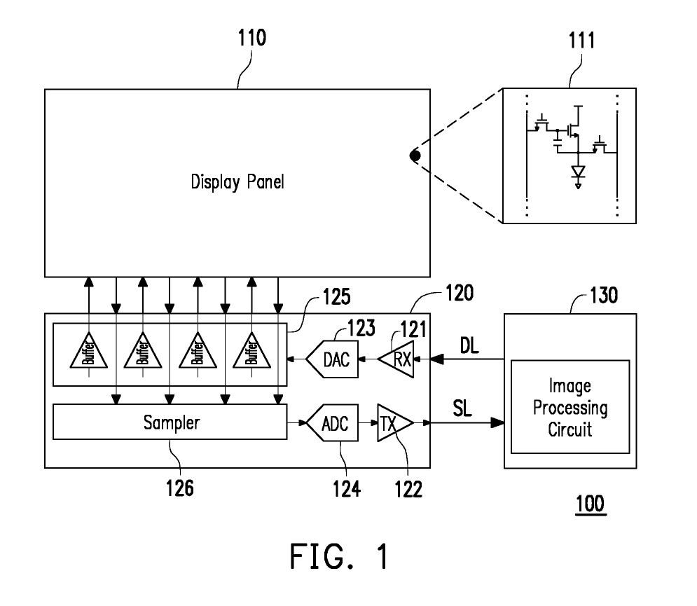

Referring to FIG. 1, a display system 100 includes a display panel 110, a driver 120 and an image processing circuit 130. The display panel 110 includes a plurality of pixels 111 which may be arranged in a matrix array or any other forms. As an example illustrated in FIG. 1, the pixel 111 includes a three transistor one capacitor (3T1C) which forms a 3T1C pixel structure. However, any layout and structure of the pixel 111 falls within the scope of the disclosure.

The driver 120 is coupled to the display panel 110 and configured to drive the display panel to display data according to at least one driving signal. Also, the driver 120 may receive at least one sensing signal. The driver circuit 120 may include a signal receiver 121, a digital-to-analog converter (DAC) 123, a driving circuit 125, a signal transmitter 122, an analog-to-digital converter (ADC) 124 and a sampler 126. The signal receiver 121 is configured to receive at least one digital signal from the image processing circuit 130 through the driving line DL. The DAC 123 is coupled to the signal receiver 121 and is configured to convert the at least one digital signal received from the signal receiver 121 to an analog signal and to output the analog signal to the driving circuit 125. The driving circuit 125 receives the analog signal from the DAC 123 and then outputs the analog signal (e.g., driving signals) to the display panel 110. The driver circuit 120 may have a plurality of channels, where each of the channel may include an operational amplifier.

The sampler 126 is coupled to the display panel 110 to receive at least one analog signal (e.g., sensing signal) from the display panel 110. The ADC 124 is coupled to the sampler 126 and is configured to converts the at least one analog signal received from the sampler 126 to a digital signal. The digital signal is provided to the signal transmitter 122, and then outputted to the image processing circuit 130 through the sensing line SL. The image processing circuit 130 is configured to perform various calculation operations related to images and signals. The disclosure is not limited to any specific structure, type or architecture of the image processing circuit 130.

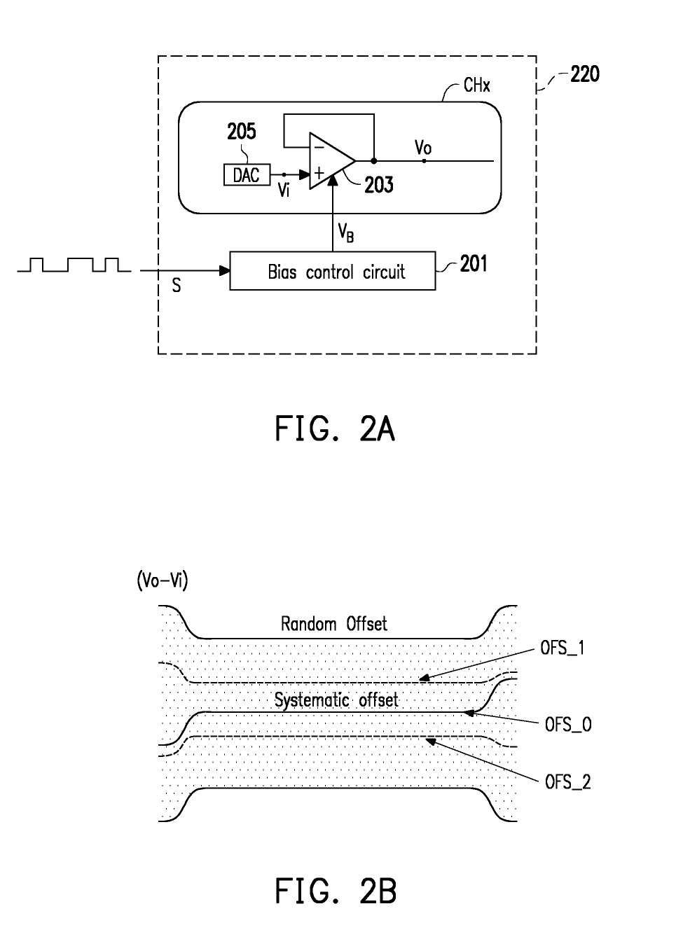

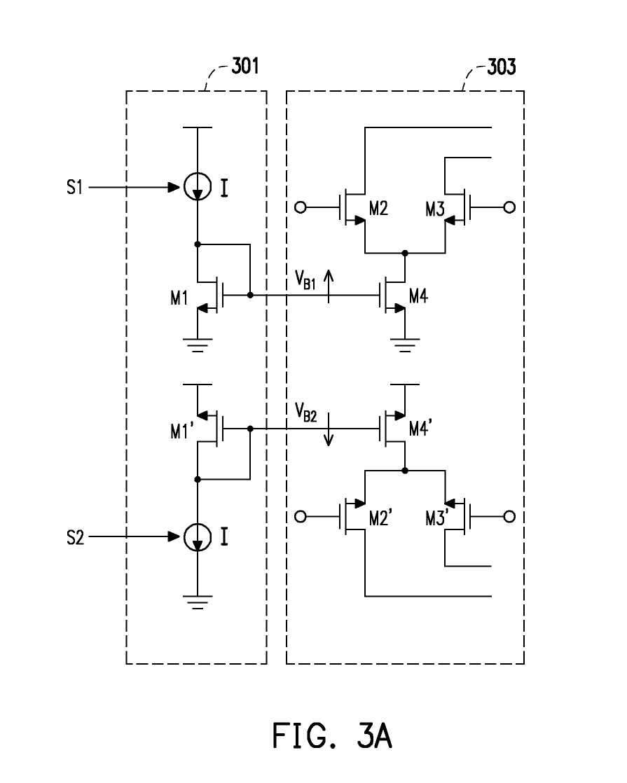

Referring to FIG. 2A, the apparatus 220 includes a bias control circuit 201, an operational amplifier 203 and a DAC 205. The DAC 205 is configured to convert a digital signal (not shown) to an analog signal Vi, and output the analog signal Vi to the operational amplifier 203. The operational amplifier 203 has an inverting terminal, a non-inverting terminal and an output terminal. The non-inverting terminal of the operational amplifier 203 is coupled to the output terminal of the operational amplifier 203, and the inverting terminal of the operational amplifier 203 is coupled to the DAC 205 to receive the analog signal Vi. The output signal Vo of the operational amplifier 203 is outputted through the output terminal of the operational amplifier 203.

It should be noted that the operation amplifier 203 may have voltage offsets which include a systematic voltage offset and a random voltage offset. The systematic voltage offset is caused by mismatches of cascaded stages of the operational amplifier 203 and is based on imperfect circuit designs; and random voltage offset is caused by imperfect manufacturing process such as an error in the size of a transistor or variations in threshold voltage.

The operational amplifier 203 is coupled to the bias control circuit 201. The bias control circuit 201 receives a signal S and generate a bias voltage V_{B} according to the received signal S to bias the operational amplifier 203. In an embodiment of the disclosure, the signal S is a random bit stream which has different level values (e.g., high level value and low level value). The bias control circuit 201 may generate the bias voltage V_{B} according to the level values of the random bit stream.

The random bit stream may be generated using linear feedback shift registers (LFSRs), but any other method and/or circuit for generating the random bit stream falls within the scope of the disclosure. Beside a random bit stream, the signal S can be a specific signal or any kind of signal that is used for the bias control circuit 201 to generate the bias voltage V_{B}. In an embodiment of the disclosure, the bias signal S may be used for biasing ratio control of the operational amplifier 203.

Referring to FIG. 1 and FIG. 2A, the driving circuit 125 may include a plurality of channels, and the DAC 205 and the operational amplifier 203 are associated with one of the channels of the driving circuit 125. The bias control circuit 201 may be considered as a channel bias control circuit which adjusts the voltage offsets of the operational 203 of the corresponding channel CHx.

FIG. 2B illustrates a difference of the output voltage Vo and the input voltage Vin of the operational amplifier 203 with a random voltage offset and a systematic voltage offset. Referring to FIG. 2A and FIG. 2B, the bias control circuit 201 generates the bias voltage V_{B} according to the signal S, and provides the bias voltage V_{B} to the operational amplifier 203 to adjust the systematic voltage offset of the operational amplifier 203. As shown in FIG. 2B, the original voltage systematic value OFS_O is adjusted to a value within a systematic offset range which is defined by OFS_1 and OFS_2. By adjusting the systematic voltage offset of the operational amplifier 203, the influences of the voltage offsets are mitigated such that the display image is smoothened and the display quality of the display panel is improved.

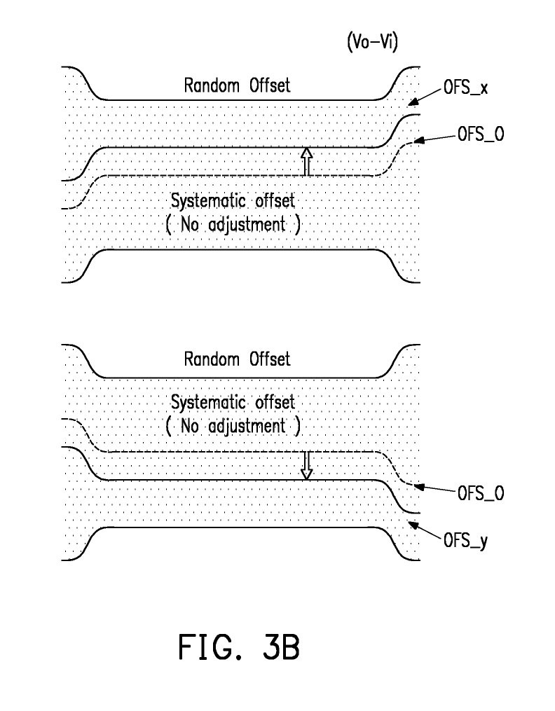

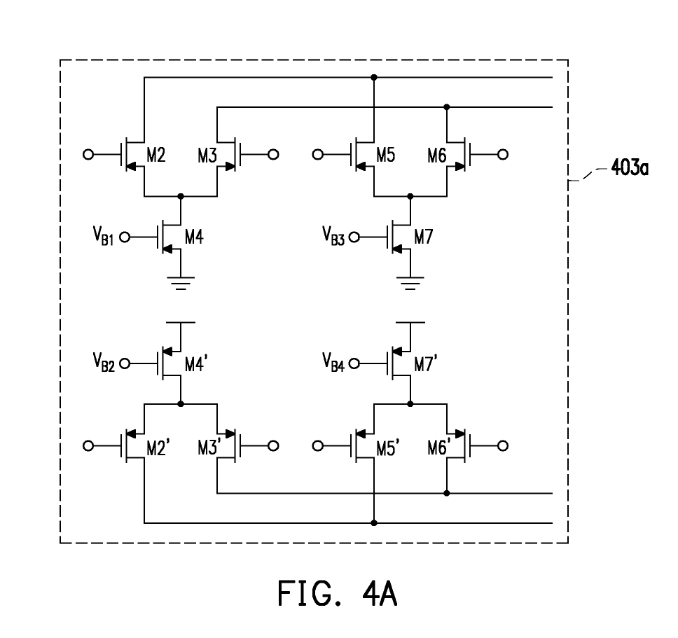

Referring to FIG. 3A, the detailed structures of the operational amplifier 303 and the bias circuit 301 are illustrated. The bias circuit 301 includes a current source I and a transistor M1. The drain terminal and the control terminal of the transistor M1 are coupled to the current source I and the source terminal of the transitory M1 is coupled to the ground. The bias circuit 301 may receive the signal S1, and the current source I generates a current according to the signal S1. If the signal S1 is a random bit stream, the value of the current generated by current source may be changed according to the level of the random bit signal S1. The bias circuit 301 may generate the bias voltage V_{B1} according to the current generated by the current source I. In other words, the bias circuit 301a may generate the bias voltage V_{B1} according level of the signal S1.

The bias circuit 301 may further include a transistor M1′ which is coupled to another current source I. The bias circuit 301 receives a signal S2 which may be a random bit stream and generates a bias voltage V_{B2} according level of the signal S2. The signals S1 and S2 provided to the bias circuit 301 may be the same or different; and the current sources of the bias circuit 301 may be the same or different.

The operational amplifier 303 may include a differential difference amplifier which includes transistors M2 to M4. The drain terminal of the transistor M4 is coupled to the source terminals of transistor M2 and M3; the source terminal of the transistor M4 is coupled to the ground; and the control terminal of the transistor M4 is coupled to the bias circuit 301 to receive the bias voltage V_{B1}.

The differential difference amplifier of the operational amplifier 303 may further include transistors M2′ to M4′. The drain terminal of the transistor M4′ is coupled to the source terminals of transistor M2′ and M3′; the source terminal of the transistor M4′ is coupled to the supply voltage; and the control terminal of the transistor M4 is coupled to the bias circuit 301 to receive the bias voltage V_{B2}.

As shown in FIG. 3A, the transistors M1 to M4 are n-type transistors and the transistors M1′ to M4′ are p-type transistors, but the disclosure is not limited thereto, and the circuit structure of the bias circuit 301 and the operational amplifier 303 may be slightly changed according to the types of the transistors M1 to M4 and M1′ to M4′.

Referring to FIG. 3A and FIG. 3B, when the bias voltage V_{B1} is increased, the original systematic voltage offset OFS_O is adjusted to the OFS_x. The upper arrow shown in FIG. 3A illustrates the increase of the bias voltage V_{B1} and the upper arrow shown in FIG. 3B illustrates the adjustment of the systematic voltage offset from OFS_O to the OFS_x. When the bias voltage V_{B2} is decreased, the original systematic voltage offset OFS_O is adjusted to the OFS_y. The lower arrow shown in FIG. 3A illustrates the decrease of the bias voltage V_{B2} and the upper arrow shown in FIG. 3B illustrates the adjustment of the systematic voltage offset from OFS_O to the OFS_y. The values of OFS_x and OFS_y may depend on the changed amount of the bias voltage V_{B1} and bias voltage V_{B2} respectively.

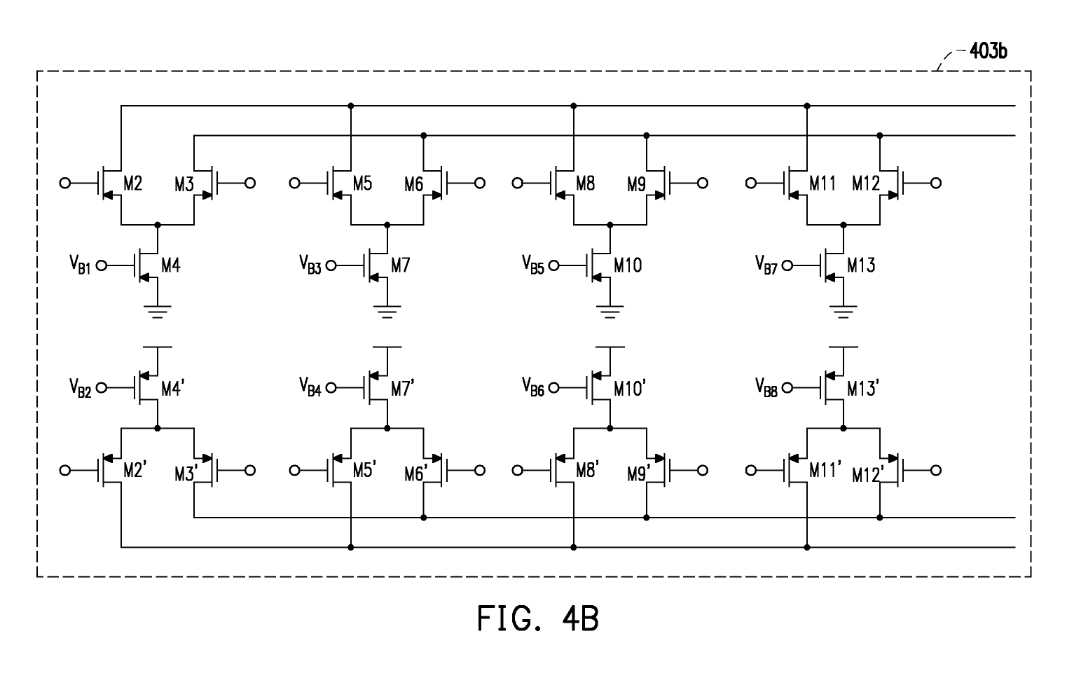

In FIG. 4A, a differential difference amplifier of the operational amplifier 403a includes transistors M1 to M4 and transistors M1′ to M4′. The drain terminal of M4 is coupled to the source terminals of M2 and M3; the drain terminal of M7 is coupled to the source terminals of M5 and M6; the drain terminal of M4′ is coupled to the source terminals of M2′ and M3′; and drain terminal of M7′ is coupled to the source terminals of M5′ and M6′. The source terminals of M4 and M7 are coupled to ground; and the source terminals of M4′ and M7′ receive a supply voltage. The control terminals of M4, M4′, M7 and M7′ receive the bias voltages V_{B1}, V_{B2}, V_{B3} and V_{B4}, respectively. The bias voltages V_{B1}, V_{B2}, V_{B3} and V_{B4} may be the same or different.

Similarly, in FIG. 4B, a differential difference amplifier of the operational amplifier 403b include transistors M1 to M12 and transistors M1′ to M12′. The detailed description of the operational amplifier 403b in FIG. 4B may be deduced by analogy with the description of the operational amplifier 403a in FIG. 4a. It should be noted that the control terminals of M4, M4′, M7 and M7′, M10, M10′, M13 and M13′ receive the bias voltages V_{B1}, V_{B2}, V_{B3}, V_{B4}, V_{B5}, V_{B6}, V_{B7} and V_{B8}, respectively. The bias voltages V_{B1}, V_{B2}, V_{B3}, V_{B4}, V_{B5}, V_{B6}, V_{B7} and V_{B8} may be the same or different.

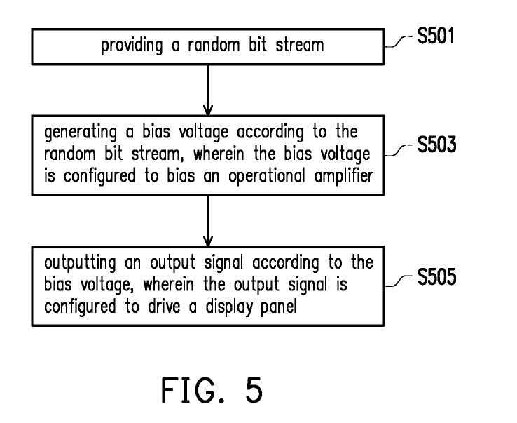

FIG. 5 illustrates a method for adjusting voltage offsets of an operational amplifier according to an embodiment of the disclosure. Referring to FIG. 1 and FIG. 5, in step S501, a random bit stream is provided to the bias control circuit 201. In step S503, the bias control circuit 201 generates a bias voltage according to the random bit stream, wherein the bias voltage is configured to bias an operational amplifier 203. In step S505, an output signal is outputted by the operational amplifier 203 according to the bias voltage, wherein the output signal is configured to drive the display panel.

From the above embodiments, a signal S (e.g., a random bit stream) is provided to a bias control circuit so that the bias control circuit generates a bias voltage according to the signal S. The bias voltage is used to bias an operational amplifier, thereby adjusting a systematic voltage offset of the operational amplifier. In this way, the issues due to voltage offsets of the operational amplifier are mitigated, and the display quality of the display panel is improved.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A driver of a display panel, the driver comprising:
an operational amplifier, outputting an output signal to drive the display panel according to a bias voltage; and
a bias control circuit, coupled to the operational amplifier and outputting the bias voltage to the operational amplifier, wherein the bias control circuit generates the bias voltage according to a random bit stream.

2. The driver of claim 1, further comprising:
a digital-to-analog converter, coupled to the operational amplifier and converting a digital signal to an analog signal, wherein the digital signal is transmitted from an image processing circuit to the digital-to-analog converter.

3. The driver of claim 2, wherein the operational amplifier comprises an inverting terminal, a non-inverting terminal and an output terminal, the non-inverting terminal of the digital-to-analog converter receives the analog signal, and the inverting terminal of the digital-to-analog converter is coupled to the output terminal of the digital-to-analog converter.

4. The driver of claim 1, wherein a systematic voltage offset of the operational amplifier is adjusted according to the bias voltage.

5. The driver of claim 1, wherein the bias voltage is changed according to signal levels of the random bit stream.

6. The driver of claim 5, wherein the bias control circuit comprises:
a current source, supplying a current according to the level of the random bit stream; and
a transistor, coupled to the current source, providing the bias voltage according to the current.

7. The driver of claim 1, wherein the operational amplifier comprises a differential difference amplifier, the differential difference amplifier comprises a first transistor, a second transistor and a third transistor,
wherein a control terminal of the first transistor is coupled to one of the inverting terminal and the non-inverting terminal of the operational amplifier, a control terminal of the second transistor is coupled to another one of the inverting terminal and the non-inverting terminal of the operational amplifier, and a control terminal of the third transistor is coupled to the bias control circuit to receive the bias voltage.

8. A method adapted to a driver of a display panel, the method comprising:
providing a random bit stream;
generating a bias voltage according to the random bit stream, wherein the bias voltage is configured to bias an operational amplifier; and
outputting an output signal according to the bias voltage, wherein the output signal is configured to drive the display panel.

9. The method of claim 8, further comprising:
converting a digital signal to an analog signal, wherein the digital signal is obtained from an image processing circuit; and
providing the analog signal to a non-inverting terminal of the operational amplifier.

10. The method of claim 8, wherein a systematic voltage offset of the operational amplifier is adjusted according to the bias voltage.

11. The method of claim 8, wherein the bias voltage is changed according to signal levels of the random bit stream.

12. A display system, comprising:
a display panel, configured to display image data according to an output signal; and
a driver, coupled the display panel, wherein the driver comprises:
an operational amplifier, outputting the output signal to drive the display panel according to a bias voltage; and
a bias control circuit, coupled to the operational amplifier and outputting the bias voltage to the operational amplifier, wherein the bias control circuit generates the bias voltage according to a random bit stream.

13. The display system of claim 12, further comprising:
an image processing circuit, coupled to the driver and outputting a digital signal to the driver,
wherein the driver further comprises a digital-to-analog converter, coupled to the operational amplifier and converting the digital signal which is received from the image processing circuit to an analog signal.

14. The display system of claim 13, wherein the operational amplifier comprises an inverting terminal, a non-inverting terminal and an output terminal, the non-inverting terminal of the digital-to-analog converter receives the analog signal, and the inverting terminal of the digital-to-analog converter is coupled to the output terminal of the digital-to-analog converter.

15. The display system of claim 12, wherein a systematic voltage offset of the operational amplifier is adjusted according to the bias voltage.

16. The display system of claim 12, wherein the bias voltage is changed according to signal levels of the random bit stream.

17. The display system of claim 12, wherein the bias control circuit comprises:
a current source, supplying a current according to the level of the random bit stream; and
a transistor, coupled to the current source, providing the bias voltage according to the current.

18. The display system of claim 12, wherein the operational amplifier comprises a differential difference amplifier, the differential difference amplifier comprises a first transistor, a second transistor and a third transistor,
wherein a control terminal of the first transistor is coupled to one of the inverting terminal and the non-inverting terminal of the operational amplifier, a control terminal of the second transistor is coupled to another one of the inverting terminal and the non-inverting terminal of the operational amplifier, and a control terminal of the third transistor is coupled to the bias control circuit to receive the bias voltage.
